(19) United States
(12) Patent Application Publication
(10) Pub. No.: US 2008/0314530 A1
(43) Pub. Date: Dec. 25, 2008

(54) Window coverings

(76) Inventor: Li-Ming Cheng, Kaohsiung City (TW)

Correspondence Address: Frenkel & Associates, P.C., Suite 330, 3975 University Drive, Fairfax, VA, 22030, US

(21) Appl. No.: 11/821,123

(22) Filed: Jun. 22, 2007

(51) Int. Cl. E06B 9/30

(52) U.S. Cl. 160/170

(57) ABSTRACT

A window coverings includes an upper and a lower elongated members, a slat assembly, a first lift cord, a second lift cord and a lift cord retracting and releasing control means. The lift cord retracting and releasing control means is located at the upper elongated member and cooperative with the first and second lift cords to control movement of the slat assembly. The first lift cord has one end fastened to the lift cord retracting and releasing control means and other end threading through the upper elongated member. The second lift cord has one end fastened and wound around the lift cord retracting and releasing control means and threading through the upper elongated member. Through coupling relationship between the first and second lift cords and the lift cord retracting and releasing control means the slat assembly already rolled up or extended at a selected elevation can be altered to another elevation.

### FIELD OF THE INVENTION

The present invention relates to a window coverings and particularly to an improved window coverings with a slat assembly adjustable to a selected elevation after retracted or extended.

### BACKGROUND OF THE INVENTION

A conventional window coverings has a slat assembly which cannot be rolled up or lowered again after retracted or extended to further move the slat assembly separately and longitudinally to alter the elevation. As a result users cannot adjust the indoor luminary condition as desired. It still has problems such as not very practical, not stable operation and the like.

### SUMMARY OF THE INVENTION

The present invention aims to provide an improved window coverings that allows a slat assembly already being retracted or extended by a first lift cord and a second lift cord to be moved longitudinally again at a desired elevation to facilitate adjustment of indoor luminary condition.

To achieve the foregoing object, the improved window coverings of the invention mainly includes an upper elongated member, a lower elongated member, a slat assembly, a first lift cord, a second lift cord and a lift cord retracting and releasing control means. The lift cord retracting and releasing control means is located at one side of the upper elongated member. The lower elongated member is spaced from the upper elongated member at a lower position. The slat assembly has a upper end and a lower end coupled respectively to the upper elongated member and the lower elongated member. The first lift cord has one end fastened to the lift cord retracting and releasing control means and other end threading through the upper elongated member. The second lift cord has one end wound around the lift cord retracting and releasing control means and threading through the upper elongated member.

By means of such a structure the following functions can be achieved: through the first lift cord, second lift cord and lift cord retracting and releasing control means, the slat assembly can be rolled up or extended downwards; then through the coupling relationship between the first lift cord and second lift cord and the lift cord retracting and releasing control means, the slat assembly can be further lifted or lowered for a selected distance; after the slat assembly is moved to the selected elevation it can be anchored through the lift cord retracting and releasing control means. Thus the elevation of the slat assembly can be altered to adjust the indoor luminary condition as desired.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a front view of the invention.

FIG. 2 is an exploded view of the lift cord retracting and releasing control means of the invention.

FIG. 3 is another exploded view of the lift cord retracting and releasing control means of the invention.

FIG. 4 is a schematic view of the invention showing the slat assembly retracted by the second lift cord.

FIG. 5 is a top view of the lift cord retracting and releasing control means for retracting the slat assembly.

FIG. 6 is another top view of the lift cord retracting and releasing control means for retracting the slat assembly.

FIG. 7 is a schematic view of the invention showing the slat assembly released by the first lift cord.

FIG. 8 is a top view of the lift cord retracting and releasing control means for extending the slat assembly.

FIG. 9 is another top view of the lift cord retracting and releasing control means for extending the slat assembly.

FIG. 10 is an exploded view of another embodiment of the lift cord retracting and releasing control means of the invention.

FIG. 11 is a perspective view of another embodiment of the lift cord retracting and releasing control means of the invention.

FIG. 12 is a schematic view of the invention showing the winding spool of the latch spool set and the upper axle sleeve in a coupling condition.

FIG. 13 is a schematic view of the invention showing the upper axle sleeve of the latch spool set moving in a downward condition.

FIG. 14 is a schematic view of the invention showing the upper and lower axle sleeves of the latch spool set in a coupling condition.

FIG. 15 is a top view of the lift cord retracting and releasing control means for retracting the slat assembly.

FIG. 16 is another top view of the lift cord retracting and releasing control means for retracting the slat assembly.

FIG. 17 is a top view of the first lift cord for extending the slat assembly.

FIG. 18 is an exploded view of yet another embodiment of the lift cord retracting and releasing control means of the invention.

FIG. 19 is a schematic view according to FIG. 18 in an assembled condition.

### DETAILED DESCRIPTION OF THE PREFERRED EMBODIMENTS

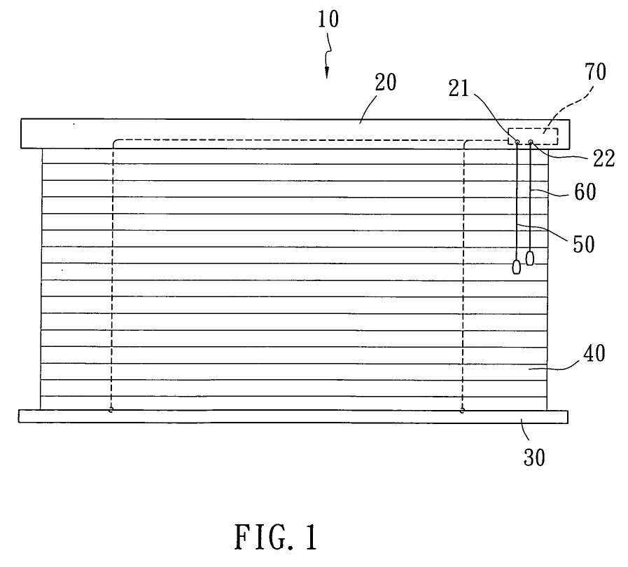

Please refer to FIG. 1, the window coverings 10 according to the invention mainly includes an upper elongated member 20, a lower elongated member 30, a slat assembly 40, a first lift cord 50, a second lift cord 60 and a lift cord retracting and releasing control means 70. The upper elongated member 20 has a trough the hold the lift cord retracting and releasing control means 70 which can wind and release the first lift cord 50 and the second lift cord 60. The upper elongated member 20 further has a plurality of openings running through the bottom such as a first opening 21 and a second opening 22 shown in the drawing.

The second elongated member 30 is spaced from the upper elongated member 20 at a lower position. The slat assembly 40 has a slat and lift cord means 80 which has a upper end and a lower end fastened respectively to the upper elongated member 20 and the lower elongated member 30. The first lift cord 50 has one end fastened to the lift cord retracting and releasing control means 70 and other end threading through the first opening 21 of the upper elongated member 20. The second lift cord 60 has one end fastened and wound around the lift cord retracting and releasing control means 70 and other end threading through the second opening 22 of the upper elongated member 20. Thereby through the first lift cord 50, second lift cord 60 and lift cord retracting and releasing control means 70 the slat assembly 40 can be steadily rolled up and extended downwards at a selected elevation.

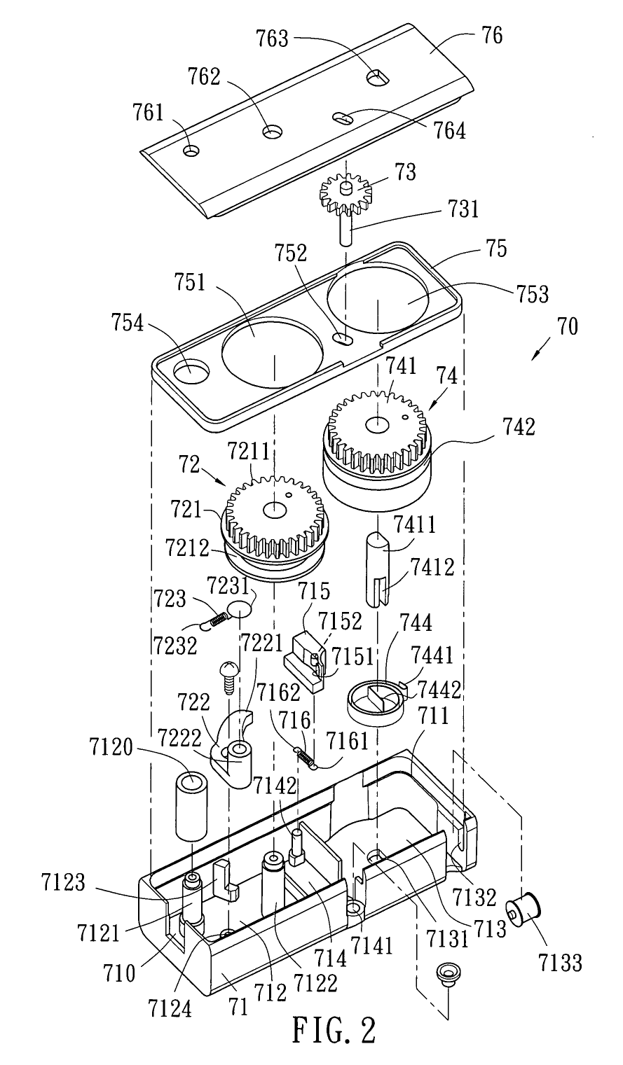

Also referring to FIGS. 2 through 6, the first and second openings 21 and 22 are located on other side of the upper elongated member 20 opposing the lift cord retracting and releasing control means 70. The lift cord retracting and releasing control means 70 is located on an inner side of the first and second openings 21 and 22 to latch and anchor the first and second lift cords 50 and 60. The lift cord retracting and releasing control means 70 mainly includes a seat 71, a ratchet and gear set 72, a driving spool 73, an auxiliary gear set 74, an locating member 75 and an upper lid 76. The seat 71 is a box with a hollow upper portion and a notch 710 at one side to receive the lift cord means 80. The seat 71 further has a recess 711 on an upper end and the interior divided into a first housing compartment 712, a second housing compartment 713 and a housing space 714 formed between them. The first housing compartment 712 holds a spindle 7121 to couple with a roller 7120 and a shaft 7122, and a bucking member 7123 at an upper position, and an anchor post 7124 and a strut 7125 on a lower position. The second housing compartment 713 has a flat bottom which has an aperture 7131 formed thereon, and a directing trough 7132 at one corner opposing the aperture 7131. The directing trough 7132 is latched with a pulley 7133. The housing space 714 has a through hole 7141 at the bottom of one side and an anchor strut 7142 at another side, and a slant rectangular opening 7143 at the bottom to hold the driving spool 73. The housing space 714 further holds a movable element 715 which has an aperture 7151 at one end and a locating bar 7152 and a trough 7153 at the bottom end. The trough 7153 holds a spring 716 which has one end 7161 latched on the locating bar 7152 and other end 7162 coupled on the anchor strut 7142 so that the movable 715 is movable in the housing space 714 through the elastic force of the spring 716. The ratchet and gear set 72 is held in the first housing compartment 712, and includes at least a winding spool 721, a stopper 722 and an elastic element 723. The winding spool 721 is coupled on the shaft 7122 of the first housing compartment 712, and has a gear 7211 on an upper end, a winding trough 7212 at a middle portion and a ratchet spool 7213 at a lower end. The winding trough 7212 is wound by the lift cord means 80. The stopper 722 is pivotally coupled on the anchor post 7124 of the first housing compartment 712 and has a latch end 7221 at one end to form a latch condition with the ratchet spool 7213 and a boss 7222 at other end. The elastic element 723 has one end 7231 to latch on the boss 7222 and other end 7232 coupled on the strut 7125. Thereby the stopper 722 can be swiveled about an axis. The boss 7222 aims to anchor the first lift cord 50. When the boss 7222 is moved the latch end 7221 is moved in the opposite direction. The driving spool 73 has a first axle 731 run through the center that is movable in the slant rectangular opening 7143. The auxiliary gear set 74 is held in the second housing compartment 713 and has a gear 741 with a second axle 7411 run through the center. The second axle 7411 has a flat surface and a channel 7412 at one end. The second axle 7411 runs through the aperture 7131 of the second housing compartment 713. The gear 741 has a winding trough 742 at a middle portion to be wound by the second lift cord 60, and a groove 743 at a lower end to hold one end 7441 of an elastic element 744 and other end 7442 latched in the channel 7412 of the second axle 7411. The locating member 75 is coupled in the recess 711 and has a first coupling hole 751, a rectangular hole 752 and a second coupling hole 753 to receive respectively the ratchet and gear set 72, driving spool 73 and auxiliary gear set 74, and a coupling opening 754 at one side to hold the roller 7120. Thereby the locating member 75 is located on an upper position of the seat 71 to allow the ratchet and gear set 72 and the auxiliary gear set 74 to form a more secure coupling and positioning relationship. The upper lid 76 is located on an upper position of the seat 71 and has a plurality of openings formed thereon. As shown in the drawings, the openings includes a first opening 761, second opening 762, third opening 763 and rectangular opening 764 to be coupled with the spindle 7121, shaft 7122, second axle 7411 and first axle 731.

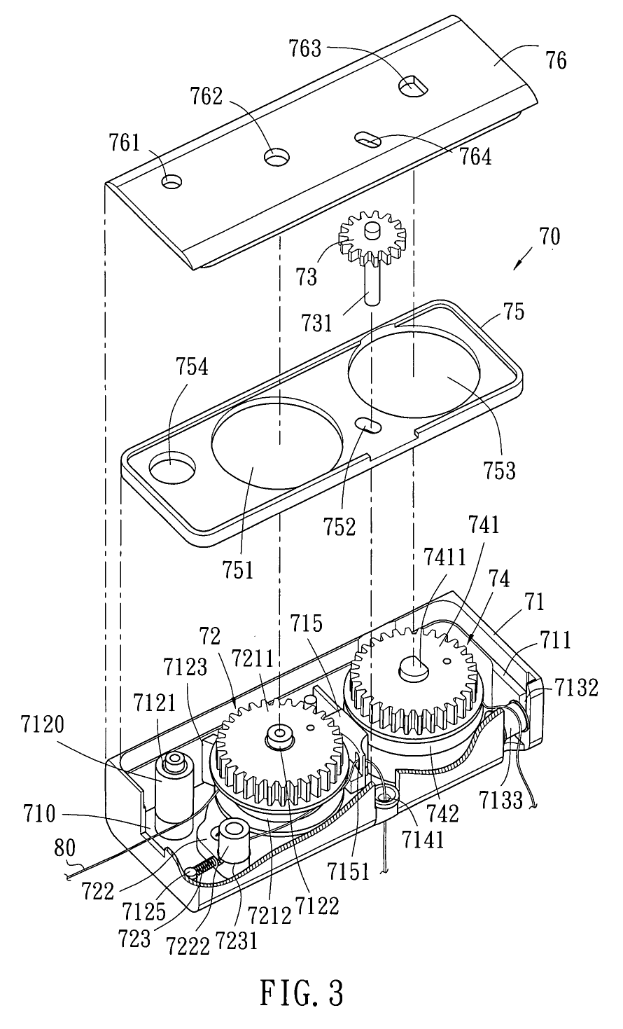

Also referring to FIG. 3, the lift cord retracting and releasing control means 70 is located on the upper elongated member 20 to control movement of the slat assembly 40 cooperative with the first and second lift cords 50 and 60. One end of the first lift cord 50 is fastened to the lift cord retracting and releasing control means 70 and other end threading through the first opening 21 of the upper elongated member 20. The second lift cord 60 has one end fastened and wound around the lift cord retracting and releasing control means 70 and threading through the second opening 22.

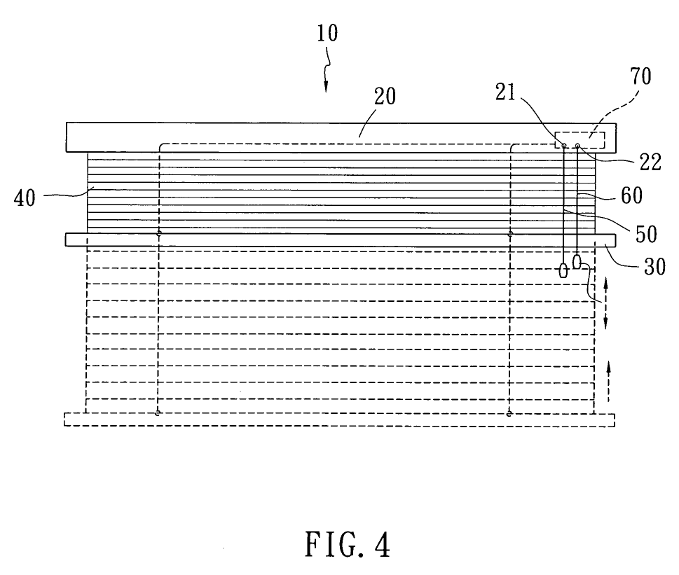

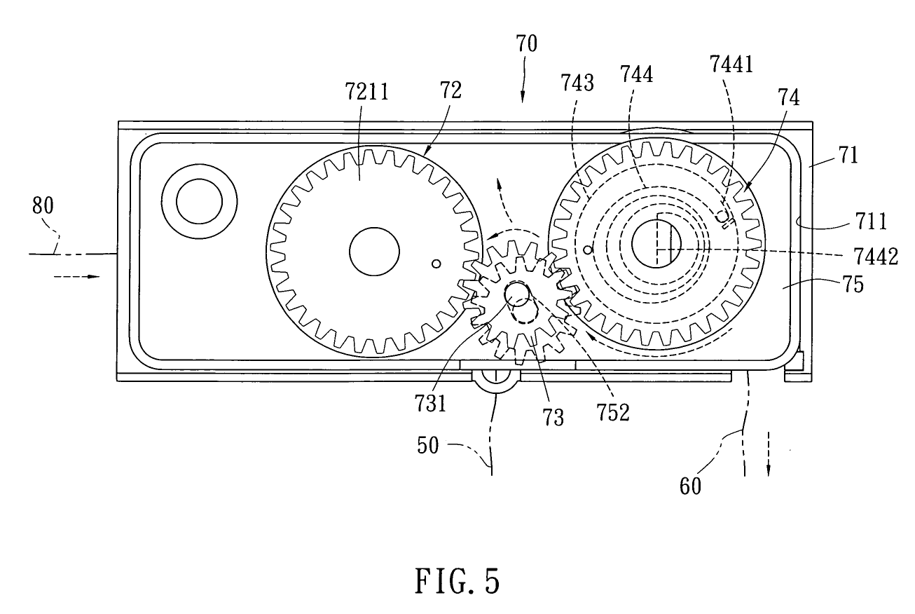

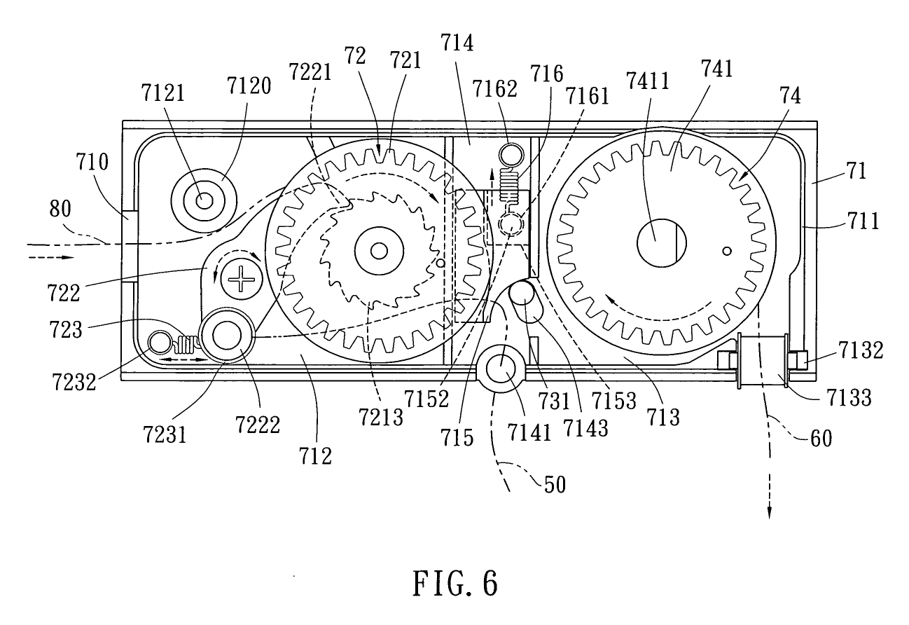

Also referring to FIGS. 4 and 5, when in use for the slat assembly 40 on the window coverings 10, pull the second lift cord 60 to move the auxiliary gear seat 74 so that the elastic element 744 at the bottom is wound; the auxiliary gear seat 74 rotates in the clockwise direction; the driving spool 73 also is turned and moved upwards to engage with the ratchet and gear set 72 so that the ratchet and gear set 72 rotates in the same direction as the auxiliary gear set 74 does. While the ratchet and gear set 72 rotates the winding trough 7212 on the winding spool 721 winds the lift cord means 80; the latch end 7221 of the stopper 722 latches on the ratchet spool 7213 at the lower end of the winding spool 721 (referring to FIG. 6), hence the slat assembly 40 is rolled upwards at a selected elevation. When the second lift cord 60 is pulled downwards continuously, the slat assembly 40 can be rolled up further again.

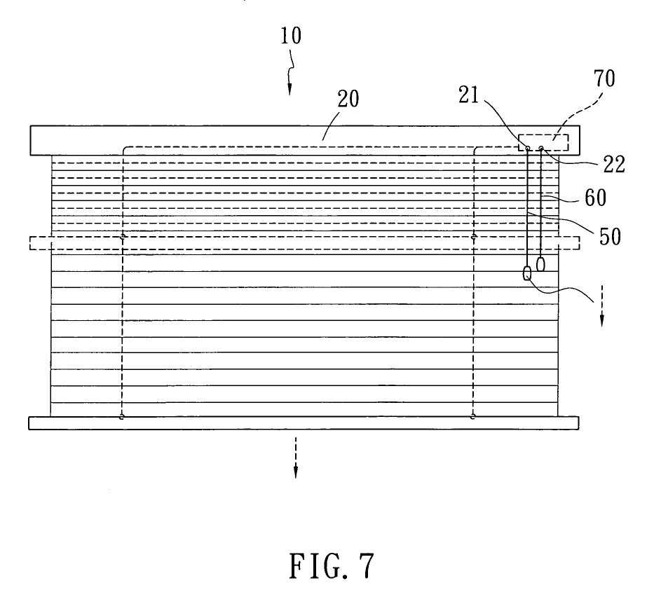

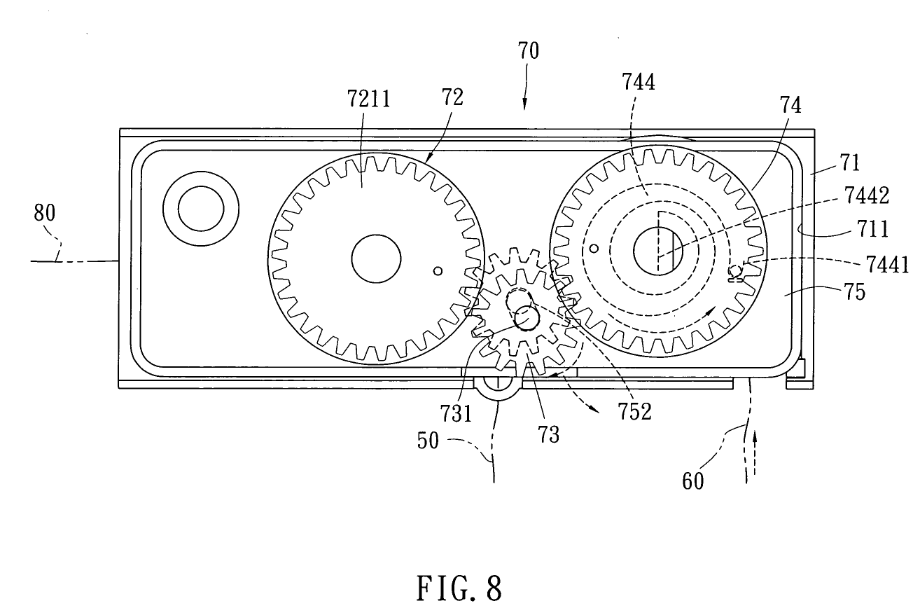

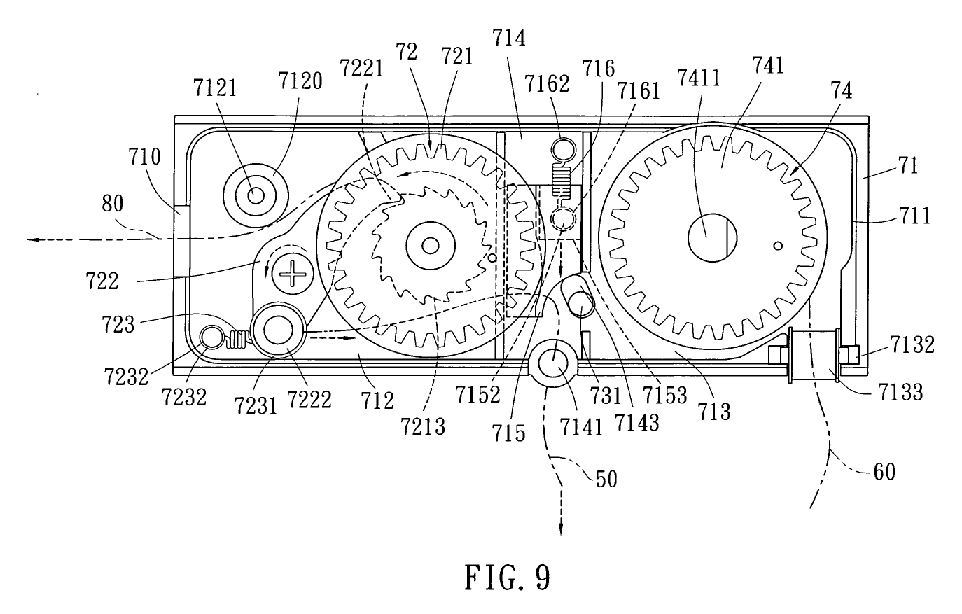

Referring to FIGS. 7 and 8, when the slat assembly 40 is lowered and extended at a selected elevation, the first lift cord 50 may be pulled downwards to return the driving spool 73 to a lower position so that the ratchet and gear set 72 is separated from the driving spool 73, and the latch end 7221 engaged with the ratchet spool 7213 is moved in the opposite direction and disengaged. Thereby the lift cord means 80 wound by the winding trough 7212 is not latched by the latch end 7221, and can be released and lowered (referring to FIG. 9). Thus the slat assembly 40 also can be lowered and extended at a selected elevation. As a result the indoor luminary condition can be adjusted as desired.

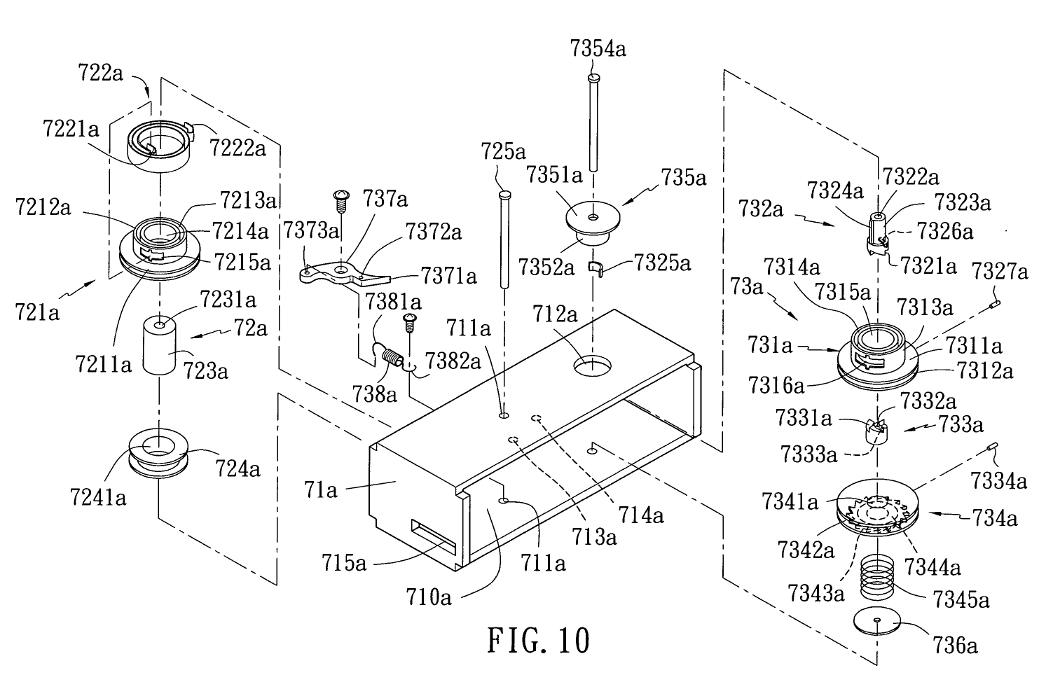

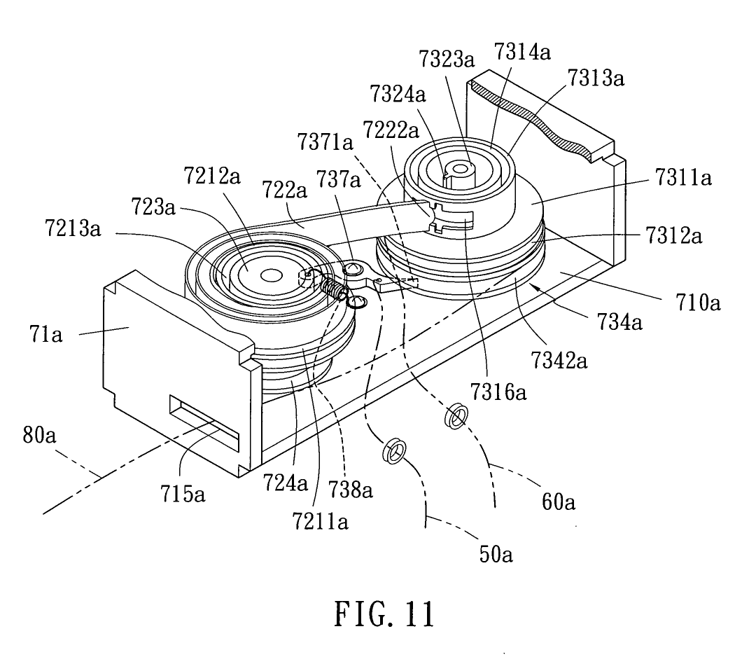

Referring to FIGS. 10 and 11, the lift cord retracting and releasing control means 70a may also include at least a frame 71a, an auxiliary spool set 72a and a latch spool set 73a. The frame 71a has a hollow housing chamber 710a, axle holes 711a, a coupling opening 712a and a plurality of apertures including a first aperture 713a and a second aperture 714a on an upper position and a lower position as depicted in another embodiment shown in the drawings. The frame 71a further has an opening 715a at one side to allow the lift cord means 80a to thread through. The auxiliary spool set 72a is pivotally coupled on the axle holes 711a and includes at least a winding spool 721a, an elastic element 722a, an axle sleeve 723a and a roller 724a. The winding spool 721a has a spool seat 7211a which has a boss 7212a extended from an upper position. The boss 7212a has a trough 7213a and a through hole 7214a running through the center thereof. There is a latch trough 7215a formed on the periphery thereof. The elastic element 722a is coupled on the boss 7212a and has respectively a hook 7221a and 7222a at an inner end and an outer end to be latched on the latch trough 7215a and the latch spool set 73a. The axle sleeve 723a has an axle hole 7231a which is coupled with the through hole 7214a and a center hole 7341a of the roller 724a which has a groove 7242a to allow the lift cord means 80a to move, and an axle 725a is provided to run through the axle hole 7231a of the axle sleeve 732a and the axle holes 711a of the frame 71a for anchoring to hinge the auxiliary spool set 72a at one side of the frame 71a.

Also referring to FIGS. 10, 11 and 12, the latch spool set 73a is hinged on the coupling opening 712a, and includes at least a winding spool 731a, an upper axle sleeve 732a, a lower axle sleeve 733a, a winding spool 734a, an upper coupling member 735a, a lower coupling member 736a, and a stopper 737a. The winding spool 731a has a spool seat 7311a which has a winding groove 7312a to allow the second lift cord 60a to wind thereon, and a boss 7313a formed thereon. The boss 7313a has a trough 7314a and a through hole 7315a running through the center of the spool seat 7311a. There is a latch trough 7316a formed on the periphery thereof to be latched by the hook 7222a formed at the outer end of the elastic element 722a. The upper and lower axle sleeves 732a and 733a are held in the through hole 7315a of the winding spool 731a and the winding spool 734a that have respectively an engaging portion 7321a and 7331a at one distal end thereof, and an axle hole 7322a and 7332a in the center. The upper axle sleeve 732a has a latch end 7324a at other end that has a shank 7232a. The shank 7323a is coupled with an arched detent member 7325a from an outside and a slant latch trough 7326a on a lower half portion to allow a pin 7327a to move thereon. The lower axle sleeve 733a has a pin hole 7333a on the periphery close to the engaging portion 7331a to hold an locating bar 7334a to fix the lower axle sleeve 733a on the winding spool 734a. The winding spool 734a is located at the bottom of the spool seat 7311a and has a coupling opening 7341a in the center to hold the lower axle sleeve 733a, and a winding groove 7242a on the periphery to allow the lift cord means 80a to wind thereon, and a ratchet spool 7343a at the bottom. The ratchet spool 7343a has a recess 7344a at one end to hold a spring 7345a. The upper coupling member 735a is held in the coupling opening 712a to allow an axle 7354a to run through to anchor the latch spool set 73a on another side of the housing chamber 710a. The upper coupling member 735a further has a detent member 7351a at the top and a wedge boss 7352a extended from the detent member. The wedge boss 7352a has a housing through 7353a inside to hold the upper axle sleeve 732a coupled with the arched detent member 7325a. The lower coupling member 736a aims to support the spring 7345a. The stopper 737a is hinged on the second aperture 714a and has a latch end 7371a at one end engaged with the ratchet spool 7343a at the bottom of the winding spool 734a. It has a threading hole 7372a close to the latch end 7371a to fasten the first lift cord 50a and an opening 7373a at other end to be latched by one end 7381a of an elastic element 738a. The elastic element 738a has another end 7382a latched on the second aperture 714a. By means of the elastic element 738a, the stopper 737a can be swiveled about one point so that when the first lift cord 50a is pulled the latch end 7371a is moved in the opposite direction.

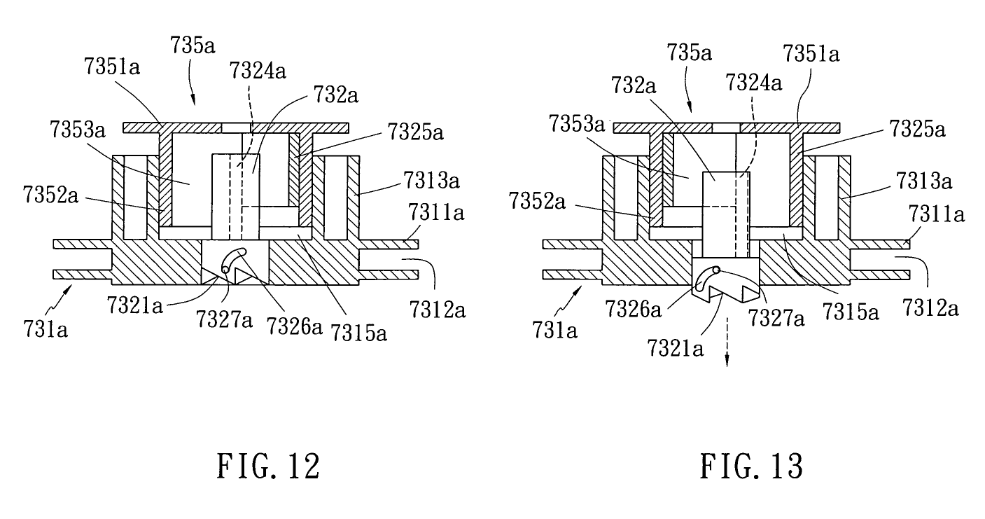

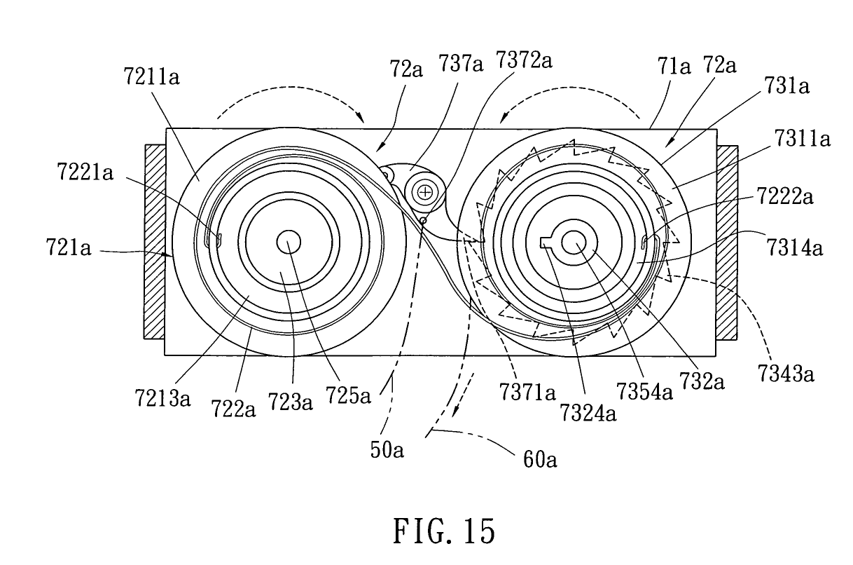

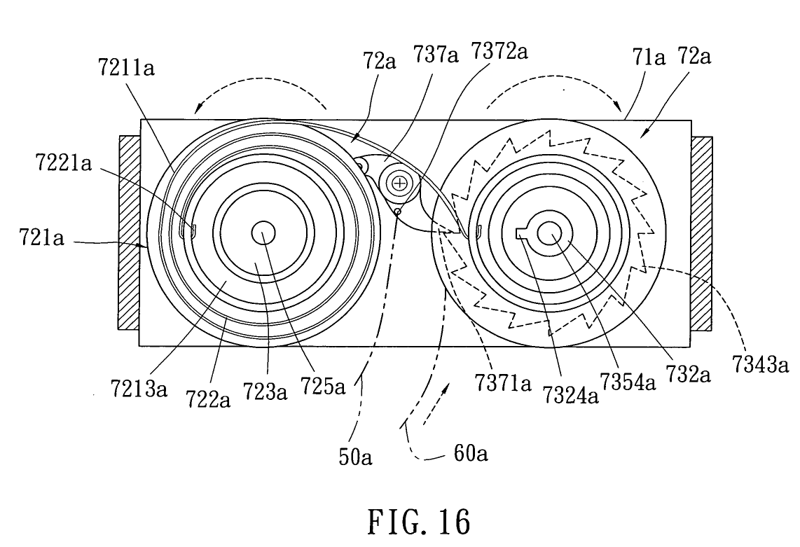

Referring to FIGS. 12, 13 and 14, when the window coverings 10 is in use and the slat assembly 40 is retracted, pull the second lift cord 60a downwards, the winding spool 721a of the auxiliary spool set 72a is wound and engaged with the winding spool 731a of the latch spool set 73a through the elastic element 722a. When the winding spool 731a is moved counterclockwise the second lift cord 60a also is wound thereon. The upper axle sleeve 732a coupled on the winding spool 731a is moved downwards through the slant trough 7326a to drive the engaged winding spool 734a held on the lower axle sleeve 733a to wind the lift cord means 80a. Meanwhile the upper axle sleeve 732a is rotated to drive the arched detent member 7325a until it is stopped at the latch end 7324a. Through the latch end 7371a at one end of the stopper 737a and the ratchet spool 7343a at the bottom of the winding spool 734a, a latched condition is formed. Hence the lift cord means 80a winding on the winding spool 734a is wound in the same direction as the winding spool 731a does. Namely when the second lift cord 60a is pulled once, the slat assembly 40 can be retracted upwards to a desired elevation. When the pulling force is released, the second lift cord 60a returns through the elastic force of the elastic element 722a already wound on the winding spool 731a (referring to FIGS. 15 and 16).

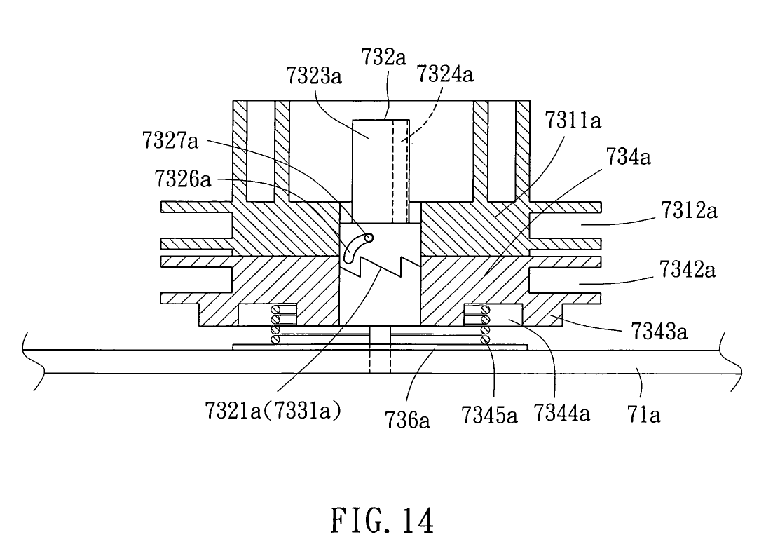

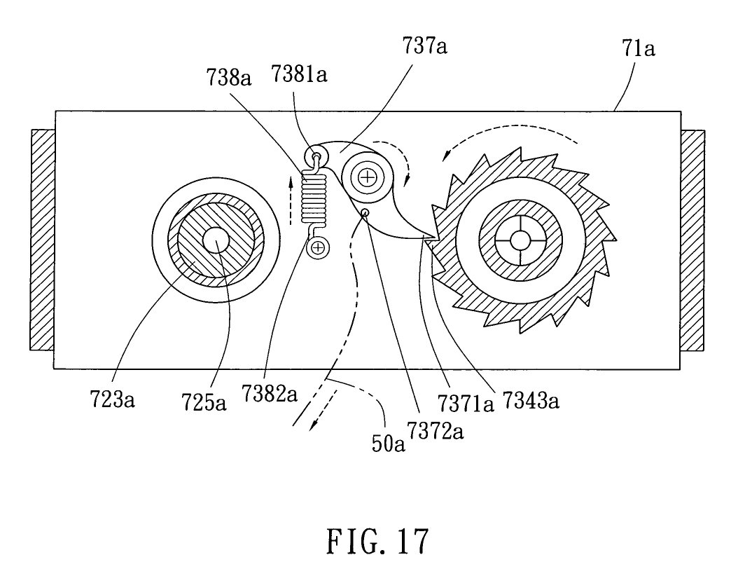

Referring to FIGS. 14 and 17, when the slat assembly 40 is extended and lowered to a selected elevation, pull the first lift cord 50a downwards, the latch end 7371a at one end of the stopper 737a escapes the ratchet spool 7343a, the lift cord means 80a wound on the winding groove 7342a of the winding spool 734a is not latched by the latch end 7371a of the stopper 737a. Hence the lift cord means 80a on the winding groove 7342a is lowered to allow the slat assembly 40 to be extended at the selected elevation. As a result users can adjust the indoor luminary condition as desired.

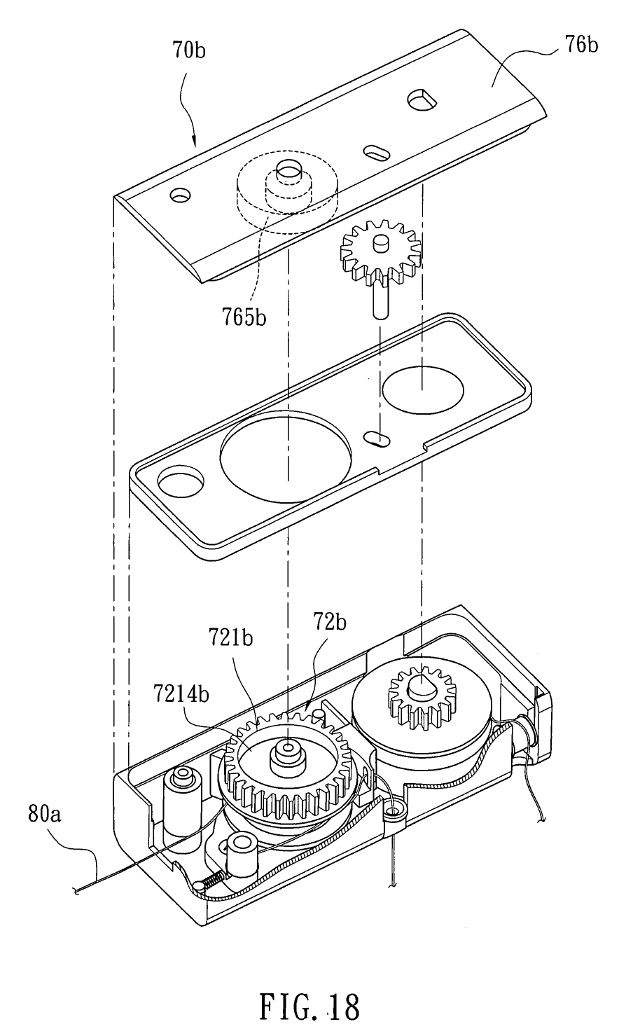

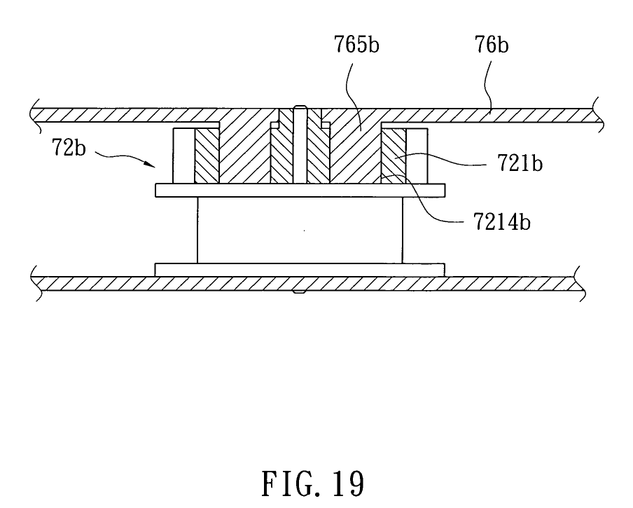

Refer to FIGS. 18 and 19 for yet another embodiment of the invention. The winding spool 721a of the lift cord retracting and releasing control means 70b has a housing chamber 7214b. An upper lid 76b is provided corresponding to the housing chamber and has a tenon 765b engaged with the housing chamber 7214b through a lubricant. Thus the lift cord means 80a can be retracted and released smoothly.

What is claimed is:

1. A window coverings, comprising at least:
an upper elongated member;
a lower elongated member spaced from the upper elongated member at a lower position;
a slat assembly which has slats and a lift cord means and an upper end fastened to the upper elongated member and a lower end fastened to the lower elongated member;
a lift cord winding and releasing control means located on the upper elongated member;
a first lift cord to control the lower elongated member to be extended downwards in a constant fashion having one end fastened to the lift cord winding and releasing control means and other end threading through the upper elongated member; and
a second lift cord to control the lower elongated member to be retracted upwards in a staged fashion having one end fastened and wound around the lift cord winding and releasing control means and other end threading through the upper elongated member.

2. The window coverings of claim 1, wherein the lift cord winding and releasing control means includes a ratchet and gear set, a driving spool, a movable member and an auxiliary gear set.

3. The window coverings of claim 2, wherein the movable member has an aperture at one end; a locating bar and a trough on a bottom end, wherein the trough holding a spring.

4. The window coverings of claim 2, wherein the ratchet and gear set includes at least a winding spool, a stopper and an elastic element.

5. The window coverings of claim 4, wherein the winding spool is coupled on a shaft and has a gear on a upper end, a winding trough at a middle portion and a ratchet spool at a lower end, the winding trough being wound by the lift cord means.

6. The window coverings of claim 4, wherein the stopper is pivotally coupled on an anchor post and has a latch end at one end to form a latch condition with the ratchet spool and a boss at another end.

7. The window coverings of claim 4, wherein the elastic element has one end latched on the boss of the stopper and other end coupled on a strut.

8. The window coverings of claim 2, wherein the driving spool has a first axle run through the center that is movable in a slant rectangular opening.

9. The window coverings of claim 2, wherein the auxiliary gear set has a gear which has a winding trough at a middle portion and a groove on a lower end to hold an elastic element.

10. The window coverings of claim 1, wherein the lift cord winding and releasing control means has an auxiliary spool set and a latch spool set.

11. The window coverings of claim 10, wherein the auxiliary spool set includes at least a winding spool, an elastic element coupled on a boss of a spool seat, an axle sleeve and a roller.

12. The window coverings of claim 11, wherein the winding spool has a spool seat which has a boss formed thereon, the boss having a trough and a through hole running through the center of the spool seat and a latch trough formed on the periphery thereof.

13. The window coverings of claim 11, wherein the axle sleeve has an axle hole and is held in the through hole of the spool seat and in a center hole of the roller which has a groove.

14. The window coverings of claim 10, wherein the latch spool set includes at least a winding spool, a upper axle sleeve, a lower axle sleeve, a winding spool, a upper coupling member, a lower coupling member and a stopper.

15. The window coverings of claim 14, wherein the winding spool has a spool seat which has a winding groove for winding the second lift cord and a boss formed thereon, the boss having a trough and a through hole running through the center of the spool seat, and a latch trough formed on the periphery thereof to latch an outer end of an elastic element.

16. The window coverings of claim 14, wherein the upper axle sleeve and the lower axle sleeve are located in the through hole of the winding spool and the winding spool, and have respectively a portion engaged with each other and an axle hole in the center thereof, the upper axle sleeve having a shank at other end that has a latch end, the periphery of the shank being coupled with an arched detent member and having a slant latch trough at a lower half portion to allow a pin to move therein, the lower axle sleeve having a pin hole on the periphery close to the engaging portion to receive an locating bar to fix the lower axle sleeve on the winding spool.

17. The window coverings of claim 14, wherein the winding spool is located at the bottom of the winding spool and has a coupling opening in the center to hold the lower axle sleeve and a winding groove on the periphery to wind the lift cord means, and a ratchet spool at the bottom that has a recess at one end to hold a spring.

18. The window coverings of claim 14, wherein the upper coupling member is held in a coupling opening and has a flange at the top and a wedge boss extended at a lower position that has a housing trough.

19. The window coverings of claim 14, wherein the lower coupling member supports a spring.

20. The window coverings of claim 14, wherein the stopper is pivotally held in the second aperture and has a latch end at one end engaged with a ratchet spool located at the bottom of the winding spool, a hole close to the latch end to fasten to the first lift cord and an opening at another end to latch one end of an elastic element.
